(19) United States
(12) Patent Application Publication
(10) Pub. No.: US 2021/0110112 A1
(43) Pub. Date: Apr. 15, 2021

(54) SYSTEM, APPARATUS AND METHOD FOR DERIVING, PRIORITIZING AND RECONCILING BEHAVIORAL STANDARDS FROM A CORPUS

(71) Applicant: Guice2, LLC, McLean, VA (US)

(72) Inventors: David L. Timm, Portsmouth, VA (US); Curtis Frost, Yorkville, CA (US)

(21) Appl. No.: 16/939,641

(22) Filed: Jul. 27, 2020

Related U.S. Application Data
(60) Provisional application No. 62/914,102, filed on Oct. 11, 2019.

(51) Int. Cl. G06F 40/289; G06F 40/35; G06F 40/253

(52) U.S. Cl. CPC G06F 40/289; G06F 40/253; G06F 40/35

(57) ABSTRACT

A system, apparatus and method derive and prioritize behavioral standards and/or imperative actions from a corpus. In various embodiments, the system, apparatus and method reconcile the behavioral standards and/or imperative actions by tagging responsibilities, authorities, restrictions, suspensions, deadlines, compliance statements, existing conflicts and inconsistencies residing within each issuance of the corpus.

### CROSS-REFERENCE TO RELATED APPLICATIONS

The present application claims priority to U.S. provisional application No. 62/914,102, filed on Oct. 11, 2019, entitled “System, Apparatus and Method for Deriving, Prioritizing and Reconciling Behavioral Standards from a Corpus”, the contents of which are incorporated by reference herein in their entirety.

### BACKGROUND

The present disclosure relates generally to natural language processing and more particularly to deriving, prioritizing and reconciling behavioral standards from a corpus of ingested documents. In various embodiments, these operations are based on the specific sentences or statements which compel human behavior and accountability.

Many types of natural language search systems exist. For example, current systems can search multiple sources to find specific words or sentence fragments. Also, various websites and web-based systems can produce a list of individual results containing a requested search term or expression. However, there is currently no capability or system which can search a singular document or multiple documents to find and produce directives (e.g., in writing or via other communication form) in a manner which enables the user to correlate, assess, analyze and prioritize the results as described herein.

For example, all governmental organizations (e.g., federal, state and local) and multitudes of other organizations (e.g., corporations, associations, leagues, etc.) produce guidance documents, specifying the assigned duties, responsibilities, tasks and guidelines of behavioral standards for individuals of various positions and status. The guidance documents can be in the form of policy directives, instructions and manuals, for example. The guidance documents can be voluminous (e.g., exceeding one thousand documents), with inconsistencies, redundancies and outdated, unprioritized information. Individuals expected to comply with such guidance can be quickly overwhelmed with such inconsistent, redundant and unprioritized directives, leaving the individuals unsure of what tasks to undertake and when, for example. Without an accurate and current accounting of their behavioral standards, organizations such as governments and corporate bodies often leave individuals and groups with conflicting standards that cannot be followed, or with so many standards that little time is left to attend to items of high priority. Time, resources, effort and funding are often wasted or put to ineffective use as a result. Further, if the organization does not have an accurate accounting of their behavioral standards, there is no effective way to update the guidance for compliance.

There is no current technological capability to ingest multiple selected documents in a manner that identifies, counts, assesses and/or analyzes the guidance which compels human behavior, and further which can produce a comprehensive list of compliance statements within a single document or within all of the selected documents and optionally address priorities and inconsistencies.

### BRIEF SUMMARY

The present disclosure relates generally to a system, apparatus and method for deriving and prioritizing behavioral standards and/or imperative actions from a corpus. In various embodiments, the system, apparatus and method further reconcile the behavioral standards and/or imperative actions by tagging responsibilities, authorities, restrictions, suspensions, deadlines, compliance statements, existing conflicts and inconsistencies residing within each issuance of the corpus. As disclosed herein, a system and process are provided that establish a standard for identification and assessment of multiple components which comprise a compliance statement. The system and process can further ingest a large volume of documents into a database and display behavioral standards from each document in a parsed manner down to the paragraph, sentence or sentence fragment level. The system and process can further identify and assess each potential compliance statement against the established standard to differentiate the compliance statements from the basic or other text strings of the document. The system and process can further account for and tag each validated complete or partial compliance statement with metadata to ensure proper accounting. The system and process can further tag each component of the validated compliance statement with metadata to enable searching and sorting in a comprehensive manner and in comprehensive ways. The system and process can further analyze each validated compliance statement for a priority based on factors, such as the authoritative source of the guidance, for example. In various embodiments, the systems and processes described herein facilitate sorting by organization, actor(s), responsibility, task and other elements. Further, embodiments facilitate the creation of a single electronic capability to search, review, assess and analyze all documents as if they were a single document, and to render the corpus usable by a computer system for generating an answer to a query from a user.

### BRIEF DESCRIPTION OF THE SEVERAL VIEWS OF THE DRAWINGS

FIG. 1 is a schematic diagram of an exemplary system in accordance with the present disclosure.

FIG. 2 is a diagram illustrating an exemplary process flow according to embodiments of the present disclosure.

FIGS. 3 through 6 are example reports and/or user interfaces produced in accordance with embodiments of the present disclosure.

FIGS. 7 and 8 are diagrams illustrating exemplary process flows according to embodiments of the present disclosure.

### DETAILED DESCRIPTION

The presently disclosed subject matter now will be described more fully hereinafter with reference to the accompanying drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims.

Example embodiments such as disclosed herein can be used to support any government, corporate and/or other entities that provide guidance statements. While the examples are described principally with reference to government applications, it will be appreciated that the same solutions may be applied in other applications or environments. The example embodiments described below include references to a system, a document ingestion engine, a language processing server and a communications device. Such system, engine, server and/or device may be implemented as a single computing system or as a collection of computing systems or subsystems which are communicatively coupled, directly or indirectly, and each component or subsystem of the exemplary server, engine, device and/or system can be implemented in hardware, software or a combination thereof. For example, the language processing server may be implemented as part of the document ingestion engine in certain embodiments. In various embodiments, the system, engine, server and communications device each have a processor and an associated memory storing instructions that, when executed by the processor, cause the processor to perform operations as described herein. It will be appreciated that reference to “a”, “an” or other indefinite article in the present disclosure encompasses one or more than one of the described element. Thus, for example, reference to a processor encompasses one or more processors, reference to a memory encompasses one or more memories, reference to a document ingestion engine encompasses one or more document ingestion engines and so forth.

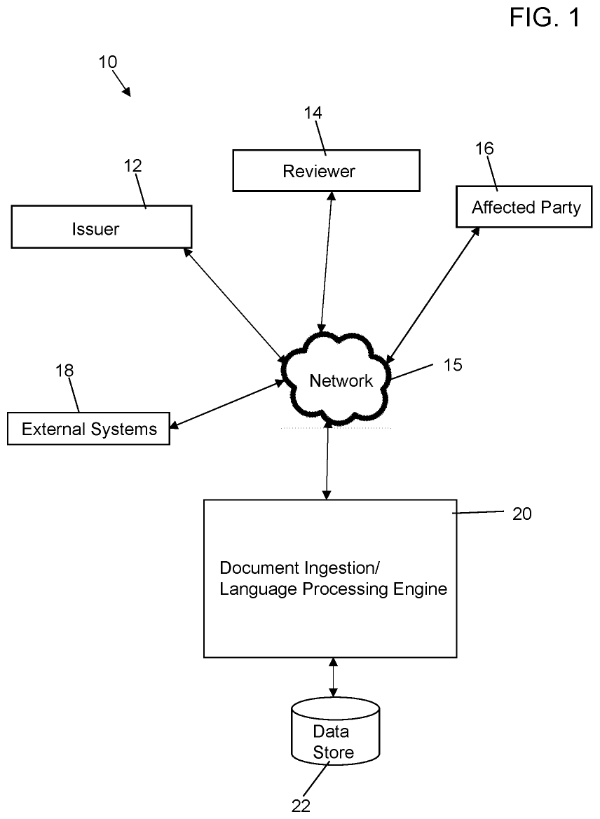

As shown in FIG. 1, embodiments of the system 10 disclosed herein can include a document ingestion and language processing engine 20 accessible by various users over a network 15. Users can include, for example, one or more issuers 12 who may issue guidance, directives, policies and similar verbal materials that include compliance statements. Issuers may be a governmental body or agency, a corporation, a manager or any other type of entity who may issue instructions that need to be followed by others. Users can also include, for example, one or more reviewers 14 and one or more affected parties 16. A reviewer 14 may be an individual accessing the engine 20 to review materials input from an issuer 12 to filter, categorize, analyze or otherwise interact with the data from the issuer 12. An affected party 16 may access the engine 20 to receive instructions and prioritized directives according to the materials that include compliance statements, for example. The engine 20 may also communicate over network 15 with one or more external sources 18 for a variety of purposes. For example, an external source 18 may have additional compliance statements that are relevant to one or more issuers 12, reviewers 14 or affected parties 16. Information from, to and/or relevant to all parties 12, 14, 16, 18 can be stored and retrieved from data store 22.

In various embodiments, standards are retrieved or created to assess and analyze issuances and compliance statements. Also, in various embodiments, the system can operate under a two-phase evaluation process to assess the content of a document or corpus of documents and then to analyze the document(s) and then specifically tag, at a metadata level, the content and appropriately process the same as described herein. The tagging allows sorting through all documents as described elsewhere herein, and facilitates providing answers to user queries, such as the body of directives that may exist in a given corpus for a person of a given category, rank or other delimiter.

In various embodiments, the present system can initiate a compliance statement standard. The standard allows the consistent identification, accounting, and analysis of the multitude of guidance requirements or tasks documented in a document or corpus. If a compliance statement standard already exists for a document or corpus, it can be employed in the present system. The standard can be applied to all possible structures of statements which specify or imply a requirement to compel human action to complete a task, for example. Whether the compelled human action is defined as guidance, an imperative, a requirement or otherwise, it is deemed to require some type of action or behavioral standard. For example, the standard for a policy statement (PS) and a compliance statement (CS) is: PS or CS=Actor+Authoritative Verb+Compliance Item. Each part of the standard is defined in Table 1 below. The lack of a standard for compliance statements creates ambiguity, misinterpretation and lack of accountability. All three components must be present in the statement in order to ensure clarity and accountability for compliance.

TABLE 1

| Term | Definition |
|---|---|
| Actor | The “noun” identifies “who” is required to complete |
| | an action/task. E.g., DoD positions of authority, DoD |
| | organizations listed by the “applicability” section; |
| | DoD Components, Agencies, Departments, Field |
| | Activities, DoD leadership positions, etc. |
| Authoritative | Specific verbs in statements, from a designated |
| Compliance | higher authority that compel compliance (e.g., |
| Verb (ACV) | must, shall, will). |
| Compliance | Mission, operation, action, task, or behavior that is |
| item (CI) | required. |

In various embodiments, applying the standard establishes the baseline to identify, count and assess policy and compliance statements from the corpus. Compliance can be considered as the: a) act or process of complying to a desire, demand, proposal, or regimen or to coercion or, b) conformity in fulfilling official requirements. For the purposes of this disclosure, all potential statements of a corpus are identified and assessed for possible compliance statements. Further, for ease of reference, it will be appreciated that a corpus for purposes of the present disclosure can be a group of documents, a single document or even a sentence or other portion of a document. Throughout the present disclosure, it will be appreciated that reference to a sentence or statement involves a form of readable text string, whether the text string originated in written or oral form.

Overall, the assessment process, using suitable programming as described herein and optionally a subject matter expert (SME), can identify and determine (categorize) a statement as a compliance statement or not. It is possible for a compliance statement to be complete or partial, and thus the system as described herein can further characterize a compliance statement as a complete compliance statement or a partial compliance statement. Once confirmed, the PS or CS can then be assigned a priority to further characterize the value of the statement for compliance, based on the authority, which can be recommended or assigned by one or more subject matter experts (e.g., a reviewer 14) or can be performed through automated textual analysis according to various embodiments of the disclosure. These priority codes can be tagged to all PSs and CSs and allow them to be further distinguished. As an example, a “priority” for compliance can be recommended for each statement based on the source of the authority reference by law or the organization or the company. This allows the Offices of Primary Responsibility (OPRs) or other involved organization to distinguish which requirements were generated within the governmental agency or body, for example. Example priority “tags” are listed in Table 2 below.

TABLE 2

| | |
|---|---|
| Priority | Authority source is above SECDEF (e.g., Public |
| 0 (P0) | Law, United States Code, Presidential Executive |
| | Order, Code of Federal Regulations, etc.). |
| Priority | Authority source is from SECDEF or delegated |
| 1 (P1) | authority from SECDEF to PSA or lower. |
| Priority | Authority source is from organization or agency |
| 2 (P2) | lower than federal authority. |

Based on the assigned priority, those policy and compliance statements which are prioritized P0 can be considered “non-discretionary” and must be accomplished. In various embodiments, an affected party 16 can review or receive such statements with a P0 priority and understand that the recited action is mandatory. In this example, those policy and compliance statements which are prioritized as P1, since they originate at SECDEF authority or below levels, can be considered for waiver. In addition, these priority codes allow the system, OPRs and leadership to prioritize work and to potentially reduce work.

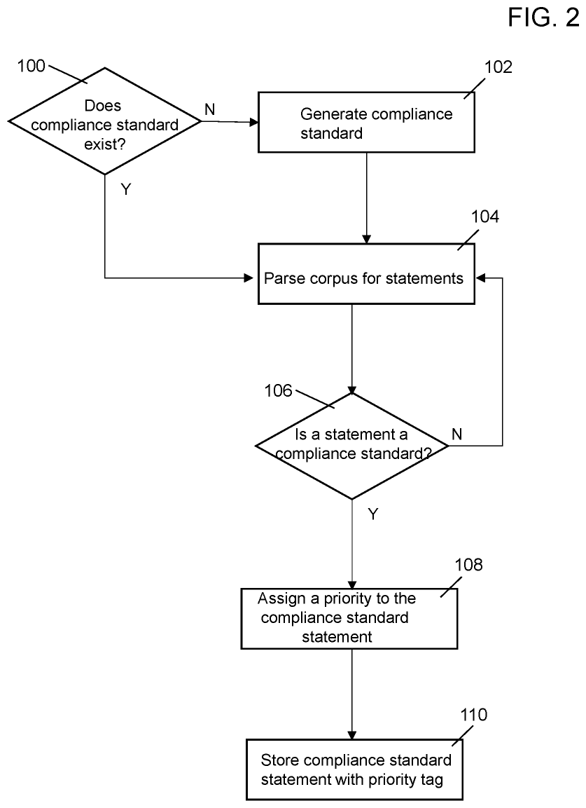

FIG. 2 illustrates a process according to embodiments of the present disclosure. As shown therein, at 100, the system determines if a compliance statement standard exists for a given project or corpus. In specific embodiments, a user 12, 14, 16 or external source 18 can send to the engine 20 the corpus of guidance regulations for storage in the data store 22. Also, the compliance statement standard may be stored in data store 22 or obtained from an external source 18, for example. The established compliance statement standard can be described logically as Compliance Statement (CS)=Actor+Authoritative Verb+Compliance Item. In another example, if a corpus is intended for a single actor, the compliance statement standard may not necessarily require the identification of an actor, as the actor would be implicitly known as the single actor for whom the corpus is intended. In such a case a compliance statement standard may be CS=Authoritative Verb+Compliance Item. For example, “Deck must be cleared” would include enough information to qualify as a compliance statement under the standard, CS=Authoritative Verb+Compliance Item. In other embodiments, possible or partial compliance statements can be identified and either separately analyzed as candidate compliance statements or removed from consideration as candidate compliance statements.

Continuing in FIG. 2, if no compliance statement standard exists, one can be generated by the engine 20 as at 102. Whether the compliance statement standard exists or is generated, the corpus is then parsed for statements as at 104.

As at 106, if a parsed statement does not qualify as a compliance statement according to the standard, the system returns to 104 to continue parsing assessment. On the other hand, if a parsed statement qualifies as a compliance statement, the compliance statement can be assigned a type code and a priority is assigned to the statement as at 108. In various embodiments, a reviewer such as an SME can independently or, as assisted by automation, review each parsed sentence of an issuance and identify individual compliance statements, assess them to the standard, assign a recommendation and then tag each with metadata. For example, each statement assessed as a PS or CS can be tagged with information identifying the actor responsible for performing the task, recommendations to better clarify the task (if applicable) and a priority number in relationship to one or more factors such as the source of the authority issuing the task. In various embodiments, the priority can be automatically assigned by the system according to a programmed standard. As at 110, the compliance standard with priority tag is then stored.

In addition to assessing compliance statements and assigning priorities, the system as disclosed herein can analyze every issuance and individual PS and/or CS occurrence using the standards and data searches to analyze for conflicts/inconsistencies across the documents. Such identification can occur by a reviewer 14 or automatically by the system.

In order to analyze the issuances for identification of conflicts and inconsistencies, the system can establish definitions, then create additional codes for identification and categorizing of findings. Exemplary definitions, with examples, are shown in Table 3 below.

TABLE 3

1. Conflict:
Most often are found in a policy statement (PS) or
compliance statement (CS).
Creates potential for inability to execute or
hold accountable.
Example: Statement tasks an organization that no
longer exists for action.
2. Inconsistency:
Ordinarily are not part of a PS or CS.
Creates potential confusion or contradiction
in guidance.
Example: Issuance references another issuance
that has been rescinded.

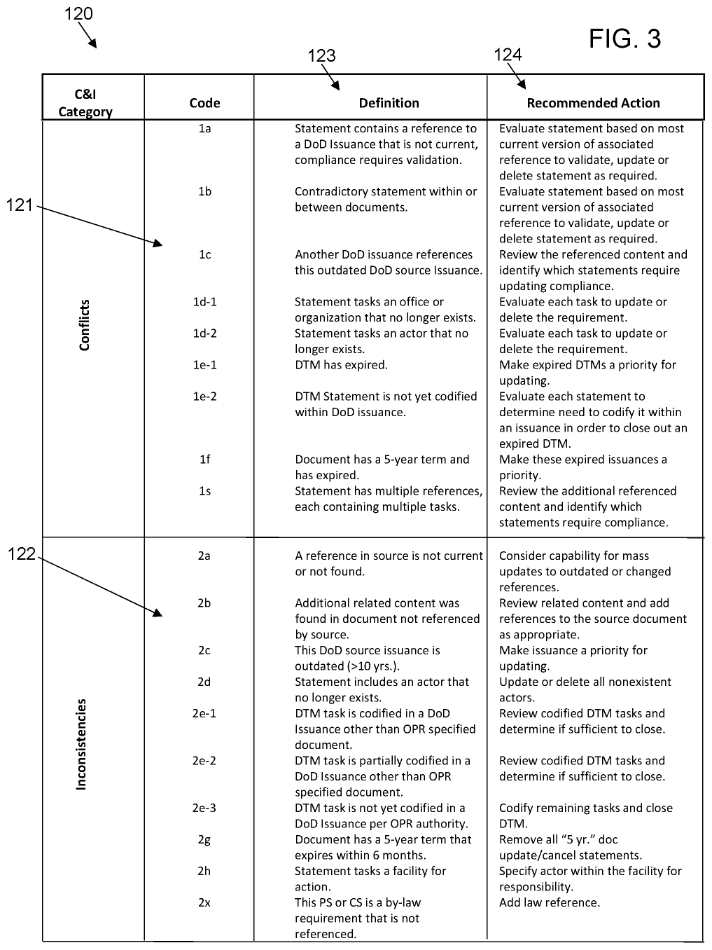

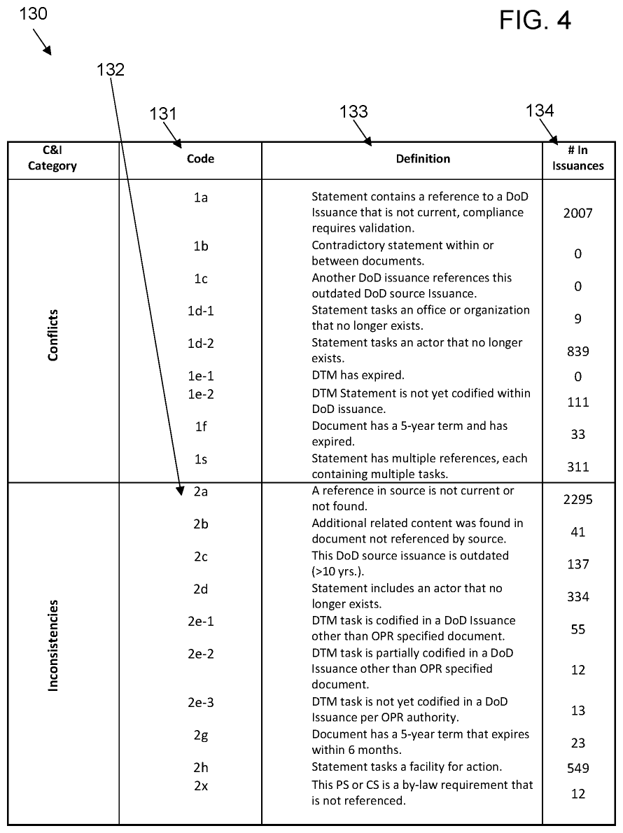

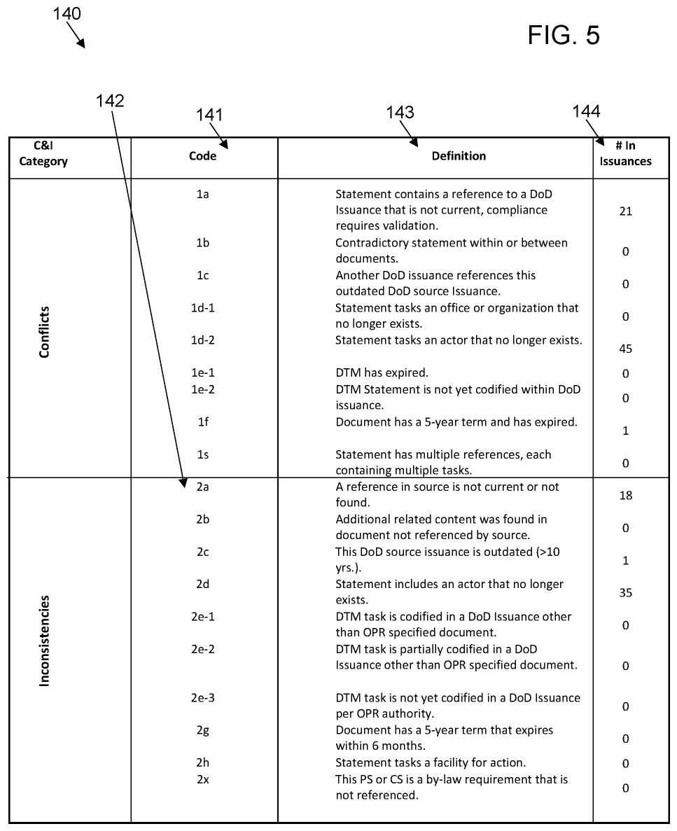

Using these definitions, the system can create codes to categorize the different types of conflicts and inconsistencies discovered. For example, those identified as a conflict can be given a code of 1 and those identified as inconsistencies can be given a code of 2. Codes 1 and 2 can be further sub-categorized, such as by adding letters. While a case can be made as to whether an item is an inconsistency verses a conflict, the real issue is that either way, they are still problems that should be fixed because they have the potential to prevent personnel from understanding and completing required tasks. FIG. 3 shows a report and/or user interface 120 of one embodiment of the conflict codes 121 and inconsistency codes 122 used, their definitions 123 and recommended actions 124. These codes are flexible and can be adjusted to meet or address any other requirements. FIGS. 4 and 5 show reports and/or user interfaces 130 and 140, respectively, of a summary of conflicts and inconsistencies in different sample issuances from an issuer. In FIG. 4, the conflict codes are shown at 131, the inconsistency codes are shown at 132, the definitions are shown at 133 and the number of issuances in the corpus are shown at 134. In FIG. 5, the conflict codes are shown at 141, the inconsistency codes are shown at 142, the definitions are shown at 143 and the number of issuances in the corpus are shown at 144. All compliance statements can then be metadata “tagged” in accordance with the identified conflict or inconsistency (e.g., identified inefficiency) which further produces the capability to search across all related compliance content across all issuances. It will be appreciated that such searching can be accommodated through a text-based, voice-based or other interactive interface that may receive input such as a user query and return a suitable response in a format suitable to be understood by the user.

It will be appreciated that compliance statement identification and metadata “tagging” in accordance with the present disclosure produces the capability to search all related compliance content across all issuances. This enables rapid identification and the ability to update compliance statements across multiple issuances when requirements change. This facilitates the streamlining of the issuance “Change” process to make content updates in multiple issuances very rapidly. It will further be appreciated that compliance statements can be correlated to labor time requirements to determine manpower needs in various embodiments.

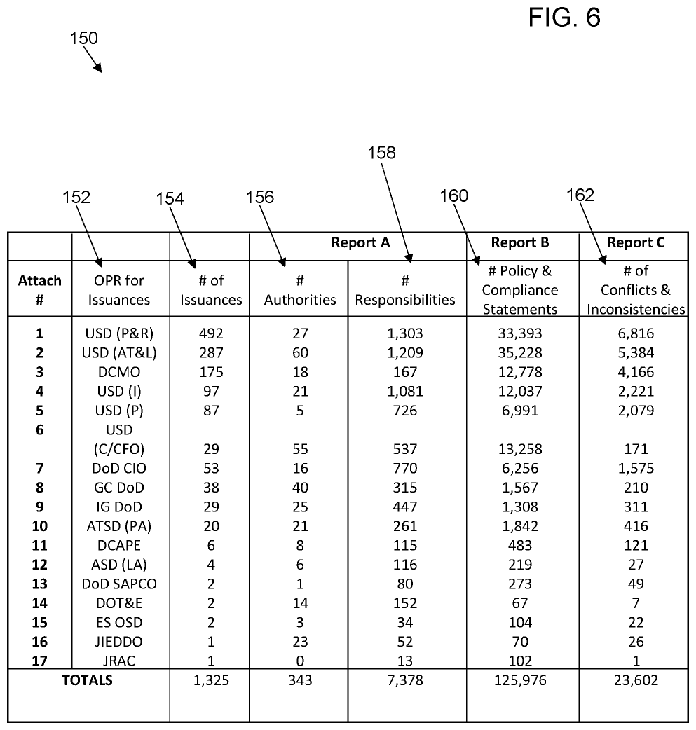

It will be appreciated that the use of a compliance statement standard ensures specific and accurate identification of the responsible official and communicates the requirement using a verb that compels action. Using a search feature in accordance with the present system, all actors (e.g., affected parties 16) can know their respective total span of responsibilities from across all documents. This information can assist in creation of compliance checklists, manpower validations/changes, creation of duties lists, creation of performance objectives, reassigning duties, etc. Ultimately, data identifying authorities, responsibilities, compliance statements, actors, recommendations, priorities, and conflicts and inconsistencies can be reported and acted upon by users of the present system. A sample summary report 150 is shown in FIG. 6, where specific OPRs are identified at 152, the number of issuances from the OPR is identified at 154, the number of authorities identified in the issuances is identified at 156, the number of responsibilities is identified at 158, the number of policy and compliance statements is identified at 160 and the number of identified conflicts and inconsistencies is identified at 162.

It will be appreciated that the presently described system thus provides users with new information and awareness about the content contained in a given corpus, including the authorities, responsibilities, compliance statements and existing conflicts and inconsistencies residing within each issuance of the corpus. Outdated, inaccurate, conflicting, and inconsistent guidance can be remedied by managing guidance at both the issuance and statement level using improved processes and technology as disclosed herein. By so doing, organizations have an opportunity to significantly improve the overall timeliness, accuracy, clarity, efficiency, effectiveness and accountability of all organizational issuances. Further, organizations are thereby empowered to make knowledge-based decisions and fix underlying conflicts and inconsistencies.

In various embodiments, the system uses programming containing logic, algorithms and/or rule sets to assess each statement in a corpus to a standard, and further to analyze statements for tagging of responsibilities, given authorities, permissions, suspensions, prohibitions, guidelines, tasks, conflicts and inconsistencies with other statements.

It will thus be appreciated that the present system provides, in part, a document ingestion and language processing engine wherein the engine has processor and a memory storing instructions that can cause the engine processor to:
receive a corpus;
parse the corpus to identify behavioral compliance statements according to a compliance standard;
generate, based on parsing the corpus, a priority metadata tag for each identified behavioral compliance statement;
generate, based on parsing the corpus, a type code metadata tag for at least a first one of the identified behavioral compliance statements; and
populate the corpus with the priority metadata tag for each identified behavioral compliance statement and the type code metadata tag for at least the first one of the identified behavioral compliance statements such that the corpus becomes usable by a computer system for generating an answer to a query from a user.

The type code metadata tag can indicate a conflict or inconsistency between the first one of the identified behavioral compliance standards and at least a second one of the identified behavioral compliance standards.

The system can further generate, based on parsing the corpus, an affected party metadata tag, an organization metadata tag and a task metadata tag for each identified behavioral compliance statement. Further, the system can populate the corpus with the affected party metadata tag, the organization metadata tag and the task metadata tag for each identified behavioral compliance statement such that the corpus becomes usable by a computer system for generating an answer to a query from a user as to the affected party, organization or task associated with each identified behavioral compliance statement.

The system can further determine a hierarchy of a plurality of tasks associated with the identified behavioral compliance statements for a first affected party based upon the priority metadata tag and the task metadata tag for each identified behavioral compliance statement. In various embodiments, the compliance standard comprises an authoritative verb and a compliance item, and may optionally include an affected party.

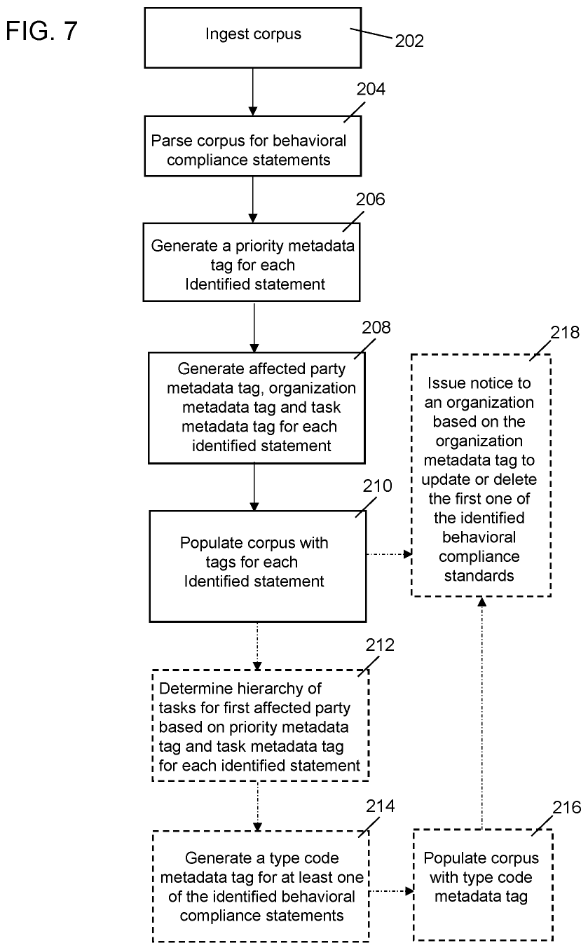

In various embodiments, such as shown in FIG. 7, a method as disclosed herein can be employed to analyze a corpus configured for use in natural language processing to render the corpus usable by a computer system for generating an answer to a user question, for example. As part of the method, a corpus is ingested as at 202, and the corpus is parsed as at 204 to identify behavioral compliance statements according to a compliance standard. The corpus can be ingested and parsed by engine 20, for example. Based on parsing the corpus, a priority metadata tag is generated as at 206 for each identified behavioral compliance statement, and an affected party metadata tag, an organization metadata tag and a task metadata tag are generated for each identified behavioral compliance statement as at 208. The engine 20 can perform the tag generation, in various embodiments. The corpus is then populated as at 210 with the priority metadata tag, the affected party metadata tag, the organization metadata tag and the task metadata tag for each identified behavioral compliance statement. The population of tags within the corpus can be accomplished by the engine 20.

In an optional embodiment as indicated in the dashed lines at 212, a hierarchy of a plurality of tasks associated with the identified behavioral compliance statements is determined for a first affected party based upon the priority metadata tag and the task metadata tag for each identified behavioral compliance statement. In a further optional embodiment as indicated at 214, based on parsing the corpus, a type code metadata tag is generated for at least a first one of the identified behavioral compliance statements and as at 216, the corpus is populated with the type code metadata tag for at least the first one of the identified behavioral compliance statements. The hierarchy determination, tag generation and population within the corpus can be accomplished by the engine 20, for example.

It will be appreciated that the type code metadata tag can indicate a conflict or inconsistency between the first one of the identified behavioral compliance standards and at least a second one of the identified behavioral compliance standards.

In various embodiments, as at 218, a communication is issued to an organization based on the organization metadata tag to update or delete the first one of the identified behavioral compliance standards. The communication can be issued by the engine, for example, and can occur after the corpus is populated at 210 or 216, for example. The compliance standard can be provided in the form of an authoritative verb and a compliance item, or as an affected party, an authoritative verb and a compliance item.

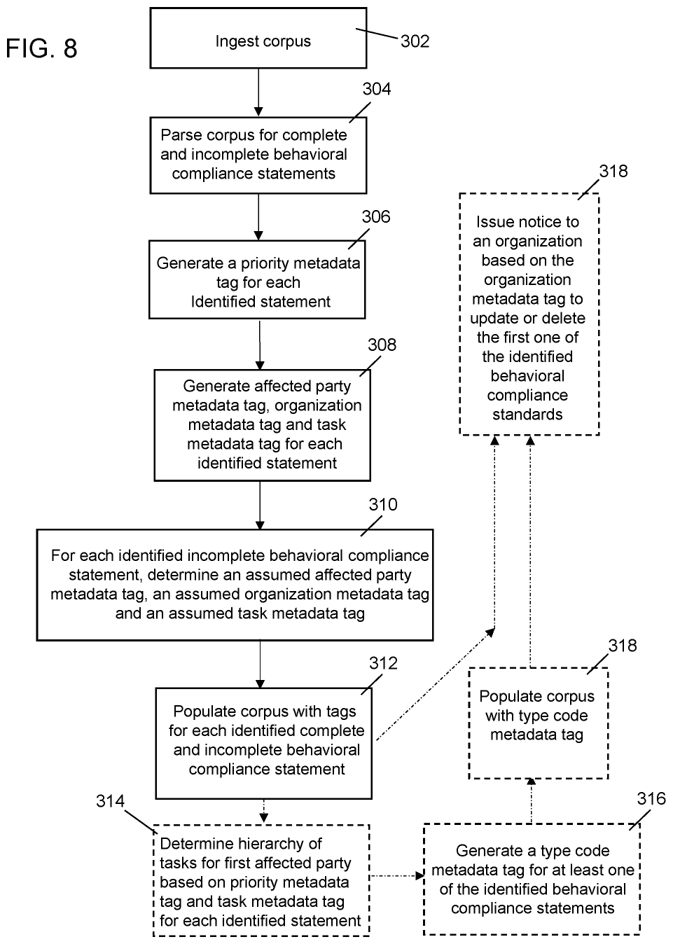

In various embodiments, such as shown in FIG. 8, a method as disclosed herein can be employed to analyze a corpus configured for use in natural language processing to render the corpus usable by a computer system for generating an answer to a user question, for example. As part of the method, a corpus is ingested as at 302, and the corpus is parsed as at 304 to identify complete behavioral compliance statements and incomplete behavioral compliance statements according to a compliance standard. The corpus can be ingested and parsed by engine 20, for example. Based on parsing the corpus, a priority metadata tag is generated as at 306 for each identified complete behavioral compliance statement, and an affected party metadata tag, an organization metadata tag and a task metadata tag are generated for each identified behavioral compliance statement as at 308. As at 310, for each identified incomplete behavioral compliance statement, an assumed affected party metadata tag, an assumed organization metadata tag and an assumed task metadata tag are determined. The engine 20 can perform the tag generation, in various embodiments. The corpus is then populated as at 312 with the priority metadata tag, the affected party metadata tag, the organization metadata tag and the task metadata tag for each identified complete behavioral compliance statement and each identified incomplete behavioral compliance statement. The population of tags within the corpus can be accomplished by the engine 20.

In an optional embodiment as indicated in the dashed lines at 314, a hierarchy of a plurality of tasks associated with the identified behavioral compliance statements is determined for a first affected party based upon the priority metadata tag and the task metadata tag for each identified behavioral compliance statement. In a further optional embodiment as indicated at 316, based on parsing the corpus, a type code metadata tag is generated for at least a first one of the identified behavioral compliance statements and as at 318, the corpus is populated with the type code metadata tag for at least the first one of the identified behavioral compliance statements. The hierarchy determination, tag generation and population within the corpus can be accomplished by the engine 20, for example.

It will be appreciated that the type code metadata tag can indicate a conflict or inconsistency between the first one of the identified behavioral compliance standards and at least a second one of the identified behavioral compliance standards.

In various embodiments, as at 320, a communication is issued to an organization based on the organization metadata tag to update or delete the first one of the identified behavioral compliance standards. The communication can be issued by the engine, for example, and can occur after the corpus is populated at 312 or 318, for example. The compliance standard can be provided in the form of an authoritative verb and a compliance item, or as an affected party, an authoritative verb and a compliance item.

The above-described embodiments of the present disclosure may be implemented in accordance with or in conjunction with one or more of a variety of different types of systems, such as, but not limited to, those described below.

The present disclosure contemplates a variety of different systems each having one or more of a plurality of different features, attributes, or characteristics. A “system” as used herein can refer to various configurations of: (a) one or more host computing devices, engines or servers; (b) one or more personal computing devices, such as desktop computers, laptop computers, tablet computers, personal digital assistants, mobile phones, and other mobile computing devices; and (c) one or more of (a) and (b).

In certain embodiments in which the system includes a personal computing device in combination with a host computing device, engine or server, the personal computing device includes at least one processor configured to transmit and receive data or signals representing events, messages, commands, or any other suitable information between the personal computing device and the host computing device, engine or server. The personal computing device can further include input/output mechanisms such as a keyboard, mouse and display or monitor. The processor of the personal computing device is configured to execute the events, messages, or commands represented by such data or signals in conjunction with the operation of the personal computing device. Moreover, the processor of the host computing device, engine or server is configured to transmit and receive data or signals representing events, messages, commands, or any other suitable information between the host computing device, engine or server and the personal computing device. The processor of the host computing device, engine or server is further configured to execute the events, messages, or commands represented by such data or signals in conjunction with the operation of the host computing device, engine or server.

In embodiments in which the system includes a personal computing device configured to communicate with a host computing device, engine or server through a data network, the data network is a local area network (LAN), a wide area network (WAN), a public network such as the Internet, or a private network. The host computing device, engine or server and the personal computing device are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium.

It will be appreciated that any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing, including a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

It will be appreciated that all of the disclosed methods and procedures herein can be implemented using one or more computer programs or components. These components may be provided as a series of computer instructions on any conventional computer-readable medium, including RAM, SATA DOM, or other storage media. The instructions may be configured to be executed by one or more processors which, when executing the series of computer instructions, performs or facilitates the performance of all or part of the disclosed methods and procedures.

Unless otherwise stated, devices or components of the present disclosure that are in communication with each other do not need to be in continuous communication with each other. Further, devices or components in communication with other devices or components can communicate directly or indirectly through one or more intermediate devices, components or other intermediaries. Further, descriptions of embodiments of the present disclosure herein wherein several devices and/or components are described as being in communication with one another does not imply that all such components are required, or that each of the disclosed components must communicate with every other component. In addition, while algorithms, process steps and/or method steps may be described in a sequential order, such approaches can be configured to work in different orders. In other words, any ordering of steps described herein does not, standing alone, dictate that the steps be performed in that order. The steps associated with methods and/or processes as described herein can be performed in any order practical. Additionally, some steps can be performed simultaneously or substantially simultaneously despite being described or implied as occurring non-simultaneously.

It will be appreciated that algorithms, method steps and process steps described herein can be implemented by appropriately programmed computers and computing devices, for example. In this regard, a processor (e.g., a microprocessor or controller device) receives instructions from a memory or like storage device that contains and/or stores the instructions, and the processor executes those instructions, thereby performing a process defined by those instructions. Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, JavaScrypt, Scala, Smalltalk, Eiffel, JADE, Emerald, C++, C #, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on a user's computer, partly on a user's computer, as a stand-alone software package, partly on a user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

1. A system for facilitating analysis of a corpus configured for use in natural language processing, comprising:
a processor and a memory storing instructions that, when executed by the processor, cause the processor to:
receive a corpus;
parse the corpus to identify behavioral compliance statements according to a compliance standard;
generate, based on parsing the corpus, a priority metadata tag for each identified behavioral compliance statement;
generate, based on parsing the corpus, a type code metadata tag for at least a first one of the identified behavioral compliance statements; and
populate the corpus with the priority metadata tag for each identified behavioral compliance statement and the type code metadata tag for at least the first one of the identified behavioral compliance statements such that the corpus becomes usable by a computer system for generating an answer to a query from a user.

2. The system of claim 1, wherein the type code metadata tag indicates a conflict or inconsistency between the first one of the identified behavioral compliance standards and at least a second one of the identified behavioral compliance standards.

3. The system of claim 1, wherein the instructions further cause the processor to:
generate, based on parsing the corpus, an affected party metadata tag, an organization metadata tag and a task metadata tag for each identified behavioral compliance statement; and
populate the corpus with the affected party metadata tag, the organization metadata tag and the task metadata tag for each identified behavioral compliance statement such that the corpus becomes usable by a computer system for generating an answer to a query from a user as to the affected party, organization or task associated with each identified behavioral compliance statement.

4. The system of claim 3, wherein the instructions further cause the processor to determine a hierarchy of a plurality of tasks associated with the identified behavioral compliance statements for a first affected party based upon the priority metadata tag and the task metadata tag for each identified behavioral compliance statement.

5. The system of claim 1, wherein the compliance standard comprises an authoritative verb and a compliance item.

6. The system of claim 5, wherein the compliance standard further comprises an affected party.

7. A computer-implemented method for analyzing a corpus configured for use in natural language processing to render the corpus usable by a computer system for generating an answer to a user question, comprising:
ingesting a corpus;
parsing the corpus to identify behavioral compliance statements according to a compliance standard;
generating, based on parsing the corpus, a priority metadata tag for each identified behavioral compliance statement;
generating, based on parsing the corpus, an affected party metadata tag, an organization metadata tag and a task metadata tag for each identified behavioral compliance statement; and
populating the corpus with the priority metadata tag, the affected party metadata tag, the organization metadata tag and the task metadata tag for each identified behavioral compliance statement.

8. The method of claim 7, further comprising determining a hierarchy of a plurality of tasks associated with the identified behavioral compliance statements for a first affected party based upon the priority metadata tag and the task metadata tag for each identified behavioral compliance statement.

9. The method of claim 7, further comprising:
generating, based on parsing the corpus, a type code metadata tag for at least a first one of the identified behavioral compliance statements; and
populating the corpus with the type code metadata tag for at least the first one of the identified behavioral compliance statements.

10. The method of claim 9, wherein the type code metadata tag indicates a conflict or inconsistency between the first one of the identified behavioral compliance standards and at least a second one of the identified behavioral compliance standards.

11. The method of claim 10, wherein the method further comprises issuing a communication to an organization based on the organization metadata tag to update or delete the first one of the identified behavioral compliance standards.

12. The method of claim 7, further comprising providing the compliance standard in the form of an authoritative verb and a compliance item.

13. The method of claim 7, further comprising providing the compliance standard in the form of an affected party, an authoritative verb and a compliance item.

14. A computer program product for analyzing a corpus configured for use in natural language processing to render the corpus usable by a computer system for generating an answer to a user question, the computer program product comprising a computer readable storage medium having program instructions embodied therewith, the program instructions executable by a computer to cause the computer to perform a method comprising:
ingesting a corpus;
parsing the corpus to identify complete behavioral compliance statements and incomplete behavioral compliance statements according to a compliance standard;
generating, based on parsing the corpus, a priority metadata tag for each identified complete behavioral compliance statement;
generating, based on parsing the corpus, an affected party metadata tag, an organization metadata tag and a task metadata tag for each identified complete behavioral compliance statement;
for each identified incomplete behavioral compliance statement, determining an assumed affected party metadata tag, an assumed organization metadata tag and an assumed task metadata tag;
populating the corpus with the priority metadata tag, the affected party metadata tag, the organization metadata tag and the task metadata tag for each identified complete behavioral compliance statement; and
populating the corpus with the priority metadata tag, the assumed affected party metadata tag, the assumed organization metadata tag and the assumed task tag for each identified incomplete behavioral compliance statement.

15. The computer program product of claim 14, further comprising determining a hierarchy of a plurality of tasks associated with the identified behavioral compliance statements for a first affected party based upon the priority metadata tag and the task metadata tag for each identified behavioral compliance statement.

16. The computer program product of claim 14, further comprising:
generating, based on parsing the corpus, a type code metadata tag for at least a first one of the identified behavioral compliance statements; and
populating the corpus with the type code metadata tag for at least the first one of the identified behavioral compliance statements.

17. The computer program product of claim 16, wherein the type code metadata tag indicates a conflict or inconsistency between the first one of the identified behavioral compliance standards and at least a second one of the identified behavioral compliance standards.

18. The computer program product of claim 17, wherein the method further comprises issuing a communication to an organization based on the organization metadata tag to update or delete the first one of the identified behavioral compliance standards.

19. The computer program product of claim 14, further comprising providing the compliance standard in the form of an authoritative verb and a compliance item.

20. The computer program product of claim 14, further comprising providing the compliance standard in the form of an affected party, an authoritative verb and a compliance item.
